(19) United States
(12) Patent Application Publication
(10) Pub. No.: US 2019/0094911 A1
(43) Pub. Date: Mar. 28, 2019

(54) System and Method for Ruggedized Remote Communication

(71) Applicant: The United State of America as represented by the Secretary of the Navy, San Diego, CA (US)

(72) Inventors: Juan Romero, Chula Vista, CA (US); Daniel Alan LaVarier, Chula Vista, CA (US)

(21) Appl. No.: 15/714,064

(22) Filed: Sep. 25, 2017

(51) Int. Cl. G06F 1/16; G06F 1/18

(52) U.S. Cl. CPC G06F 1/1656; G06F 1/1601; G02B 6/46; G06F 2200/1633; G06F 1/182

(57) ABSTRACT

A system for maintaining current link capabilities comprising a tactical computer group, a communications subsystem, and a data processing terminal, wherein the data processing terminal is configured to remotely control the tactical computer group and the communications subsystem, and wherein the tactical computer group and the communications subsystem are configured to send and receive data to and from the data processing terminal via fiber optic connections, and wherein the data processing terminal is configured to meet all shock, vibration, and environmental requirements of critical Navy shipboard equipment as well as data security requirements.

### FEDERALLY-SPONSORED RESEARCH AND DEVELOPMENT

A System and Method for Ruggedized Remote Communication is assigned to the United States Government and is available for licensing for commercial purposes. Licensing and technical inquiries may be directed to the Office of Research and Technical Applications, Space and Naval Warfare Systems Center, Pacific, Code 72120, San Diego, Calif., 92152; voice (619) 553-5118; email ssc_pac_T2@navy.mil. Reference Navy Case Number 104343.

### BACKGROUND

The Common Data Link Management System (CDLMS) is a Navy communication system functioning as an interface between a ship's combat system and its tactical data links. Tactical Data Link (TDL) systems transfer information quickly and securely between military assets. Information can be sent directly between units through ultra-high frequency (UHF) and high frequency (HF). These systems allow ground troops in one location to transmit near real-time information to a Navy ship operating in a different location. The CDLMS system is designed to enhance the ability of Navy ships to be made aware of incoming threats. The system also allows Navy ships to strike targets over the horizon by providing improved connectivity, enhanced throughput and extended range of TDLs, including Link 16.

The AN/UYQ-120(V) Command and Control Processor System (C2PS) is a Tech Refresh (TR) of the CDLMS. It is a pre-planned product improvement effort to address hardware obsolescence with the legacy CDLMS. It replaces the AN/UYQ-86 hardware system. C2PS will simplify and modernize the current hardware architecture while maintaining system reliability. C2PS will maintain all tactical data link capabilities. C2PS supports Link-22, Link-16, Sat Link-16, and Joint Range Extension (JRE) which significantly contribute to Naval Transformation by providing a multi-media (EHF/SHF) Joint Beyond Line of Sight (JBLOS) TDL capability.

C2PS is comprised of three units: Unit One is a tactical computer group. Unit Two is a communications subsystem, and Unit Three is the Ruggedized Operator Terminal, providing operator system control from a remote location for Units One and Two. It replaces the Human Machine Interface (HMI) and it requires no software for operation, and is a mirror of Units One and Two but allows remote operation for both.

### BRIEF DESCRIPTION OF THE DRAWINGS

FIG. 1A shows a top view of the Ruggedized Operator Terminal with the monitor display closed.

FIG. 1B shows a top view of the Ruggedized Operator Terminal with the monitor display opened.

FIG. 1C shows a rear view of the Ruggedized Operator Terminal assembly.

FIG. 2A shows a front view of Unit One—tactical control group.

FIG. 2B shows a front view of Unit Two—communications subsystem.

FIG. 2C shows a front view of Unit Three having a closed display—Ruggedized Operator Terminal.

FIG. 2D shows a front view of Unit Three having an open display—Ruggedized Operator Terminal.

FIG. 3 shows a block diagram of a Ruggedized Operator Terminal switch configuration.

FIG. 4 shows a block diagram of the C2P System in accordance with the Ruggedized Operator Terminal.

### DETAILED DESCRIPTION OF SOME EMBODIMENTS

Reference in the specification to “one embodiment” or to “an embodiment” means that a particular element, feature, structure, or characteristic described in connection with the embodiments is included in at least one embodiment. The appearances of the phrases “in one embodiment,” “in some embodiments,” and “in other embodiments” in various places in the specification are not necessarily all referring to the same embodiment or the same set of embodiments.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of the “a” or “an” are employed to describe elements and components of the embodiments herein. This is done merely for convenience and to give a general sense of the invention. This detailed description should be read to include one or at least one and the singular also includes the plural unless it is obviously meant otherwise.

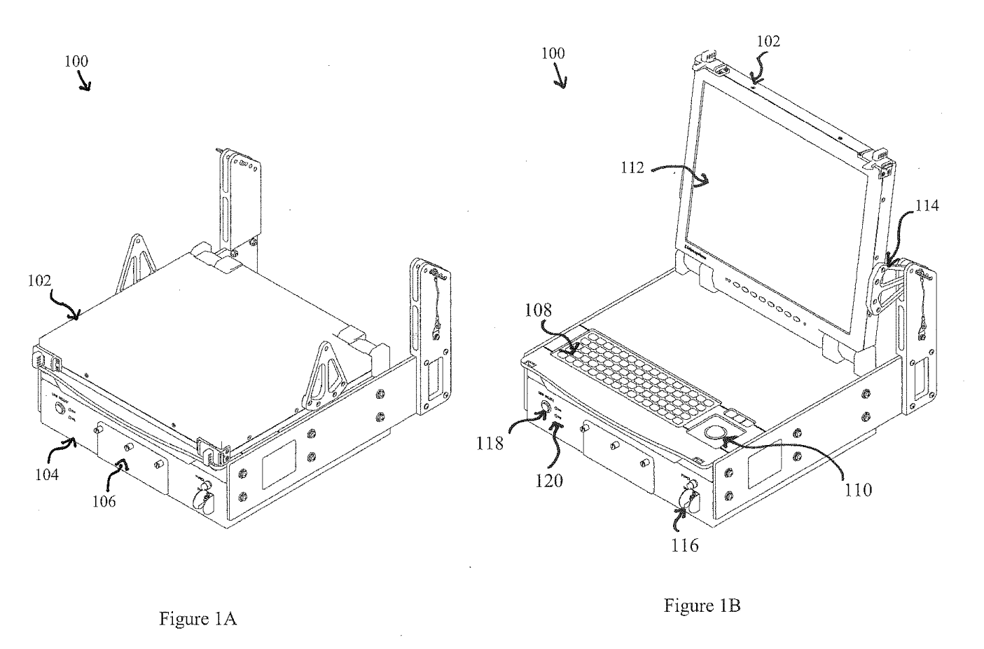

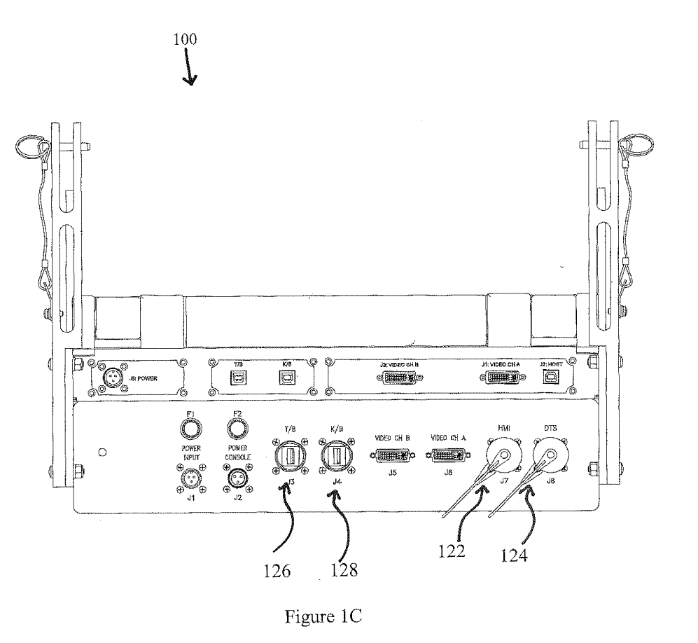

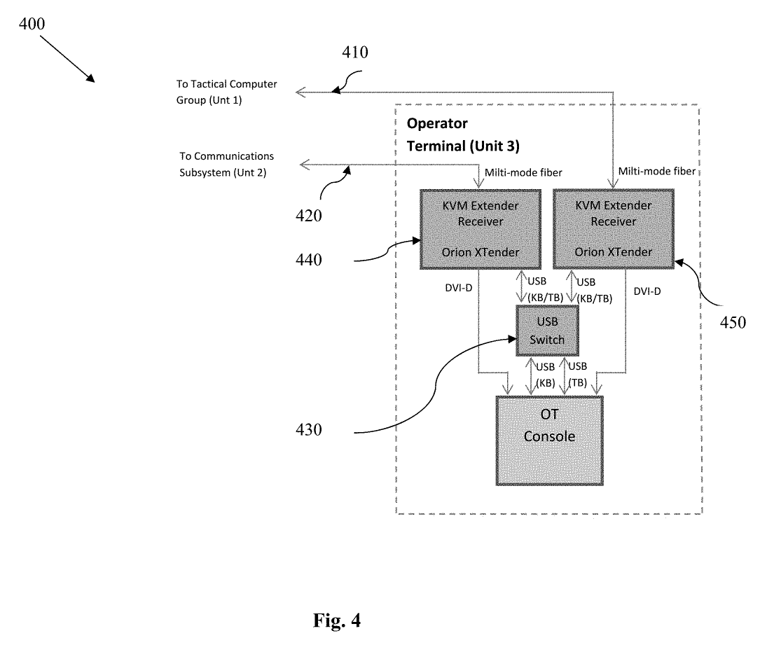

FIG. 1 shows various views of the ruggedized operator terminal 100. Ruggedized operator terminal 100 provides ruggedized remote access to a first and second computer (not shown here) via a fiberoptic interface. The remote access is controlled using a USB switch and two keyboard video mouse (KVM) extender receivers (shown in FIG. 4)—one for each computer to which ruggedized operator terminal 100 has remote access. Video signal is sent from the first and second computers to ruggedized operator terminal 100, and keyboard and trackball signals are sent back and forth between the first and second computers and ruggedized operator terminal 100. Ruggedized operator terminal 100 meets stringent environmental requirements for critical Navy shipboard electronic equipment, including shock per military standard 901D (MIL-S-901D) grade A, vibration per military standard 167-1A (MIL-STD-167-1A), Temperature and Humidity per military standard 810G (MIL-STD-810G), and electromagnetic interference per military standard 461-F (EMI per MIL-STD-461F).

FIG. 1A shows a top view of ruggedized operator terminal 100 with a command console 102 in the closed position. One embodiment specifically uses the Z Microsystem Command Console. A metal electromagnetic interference (EMI) enclosure 104 houses electronics equipment, such as the keyboard video mouse (KVM) extender receivers and USB switch (shown in FIG. 4), and has an EMI sealed viewing port 106 on the front which allows internal viewing of the KVM extender receivers. One embodiment is designed to specifically house a Rose Electronics KVM Extender Receiver. All electronics components and circuit cards within ruggedized operator terminal 100 are hardened to meet MIL-S-901D Grade A shock.

FIG. 1B shows a top view of ruggedized operator terminal 100 with command console 102 in the open position. Command console 102 has a keyboard 108, a trackball 110, and a display monitor 112. Display monitor 112 has an adjustable viewing angle. In one embodiment, display monitor 112 is a 19-inch LCD scaled support resolution (1920×1200). Command console 102 has ruggedized adjustable mounting brackets 114 and a hardened on/off power switch 116.

Ruggedized operator terminal 100 can remotely access a first and a second computer, but command console 102 only allows keyboard mouse (KM) access for one computer at a time, while the other computer can be viewed using a Picture-in-Picture console feature. A USB toggle button 118 allows a user to switch back and forth between the first and second computers. Light indicators 120 allow identification of the computer that has KM control. As mentioned earlier, video signal is sent via fiber optics from the first and second computers to ruggedized operator terminal 100. The KVM Extender Receivers (shown in FIG. 4) convert the fiber optic signals sent from the first and second computer back into Digital Video and USB (for KM control). The converted Video and USB signals are interfaced from EMI enclosure 104 to command console 102 via external cables connected to video ports (as seen in FIG. 1C). Additionally, light pipes (not shown here) located inside EMI enclosure 104 have one end placed over USB port selection toggle button 118 and the other end is placed so that the light is visible in light indicators 120 from the front end of the enclosure. USB toggle button 118 is soldered to the switch selection button wires (not shown here). Metal brackets inside EMI enclosure 104 properly secure light pipes, USB Switch, and toggle button 118 sufficiently well to meet required shock and vibe requirements.

FIG. 1C shows a rear view of ruggedized operator terminal 100, with various plug-in ports such as console video ports 122 and 124 that allow for video switching, and also USB ports 126 and 128.

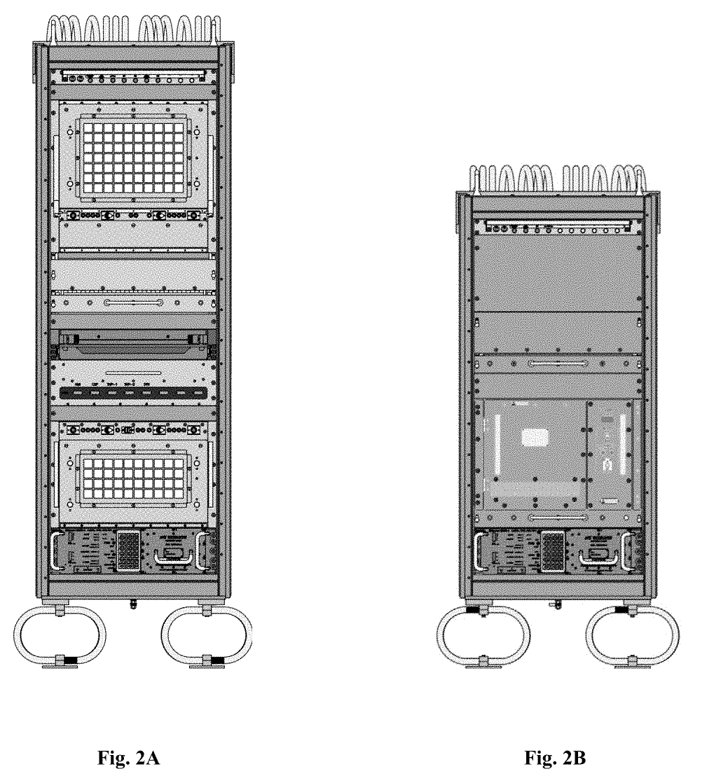

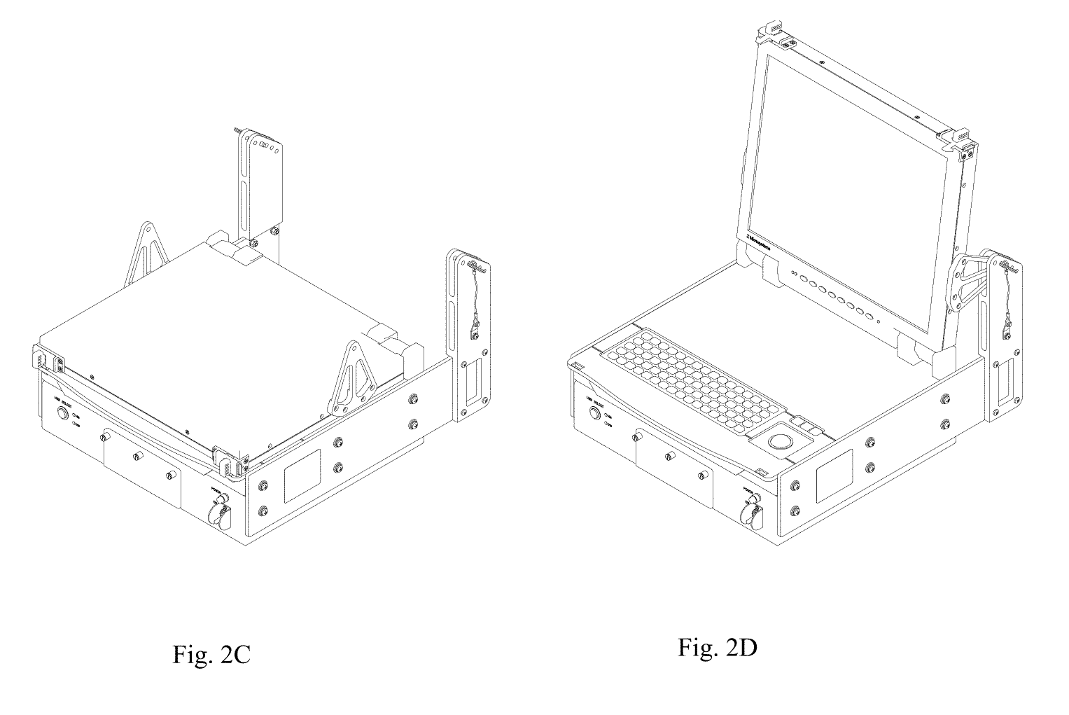

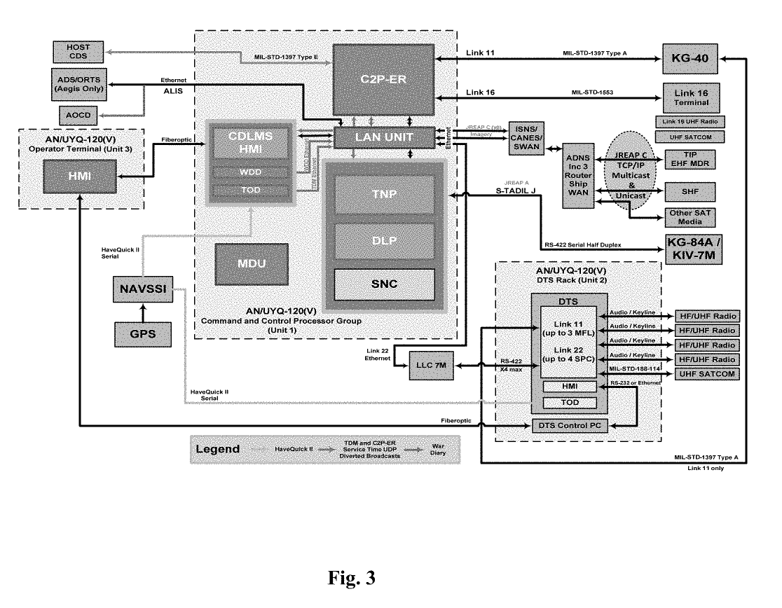

FIGS. 2A-2D show the three units that make up the C2PS System: FIG. 2A Tactical Computer Group—Equipment Rack (TCG-ER) Unit One houses C2P and HMI Single Board Computers, and incorporates a Maintenance Console Assembly using secure KVM technology. It has tactical network processor (TNP)-provided JRE and STJ functions.

FIG. 2B shows a Communication Subsystem Equipment Rack (CS-ER) Unit Two providing Link-11 and Link-22 capability control and processing.

FIGS. 2C-2D show a Ruggedized Operator Terminal (ROT) Unit Three that does not require software to operate, but rather provides remote operator system control of Units One and Two. FIG. 2C shows a Ruggedized Operator Terminal having a closed display, and FIG. 2D shows a Ruggedized Operator Terminal having an open display. Unit Three communicates with Unit One and Unit Two via a fiberoptic interface.

FIG. 3 shows a block diagram of a Ruggedized Operator Terminal switch configuration.

FIG. 4 shows a block diagram of the switch configuration of a ruggedized operator terminal 400. Ruggedized operator terminal 400 connects remotely to Unit One and Unit Two referenced in 2A-2B via a fiber optic interface 410 and 420. A USB switch 430 and KVM extender receivers 440 and 450 are used to control the remote connection.

The ruggedized operator terminal could be used for any other application requiring a ruggedized secure operator terminal to remotely access and control one or two critical processors in a shipboard, airborne, or all-terrain vehicle environment. Various diagrams of the ruggedized operator terminal are shown below, along with a legend for the corresponding components.

Preferred embodiments are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A system for maintaining tactical data link capabilities comprising:
a tactical computer group, a communications subsystem, and a ruggedized operator terminal, wherein the ruggedized operator terminal is configured to remotely control the tactical computer group and the communications subsystem, and wherein the tactical computer group and the communications subsystem are configured to send and receive data to and from the ruggedized operator terminal via a fiber optic interface, and wherein the ruggedized operator terminal is configured to meet all shock, vibration, and environmental requirements of critical Navy shipboard equipment s well as data security requirements.

2. The system of claim 1, wherein the ruggedized operator terminal comprises a Command Console, wherein the Command Console comprises a display monitor, a keyboard, and a trackball, and wherein the Command Console is operably coupled to a metal electromagnetic interference (EMI) enclosure.

3. The system of claim 2 wherein the ruggedized operator terminal remotely controls the tactical computer group and the communications subsystem via a fiber-optic interface.

4. The system of claim 3, wherein the tactical computer group and the communications system comprise a keyboard video mouse (KVM) extender transmitter unit, and wherein the ruggedized operator terminal comprises two KVM extender receivers.

5. The system of claim 4 wherein the KVM extender receivers are shock and vibration isolated via hemisphere bumpers.

6. The system of claim 5 wherein the Command Console further comprises an electromagnetic interference (EMI)—sealed viewing port.

7. A system comprising:
a Human Machine Interface (HMI) Operator Terminal comprising a Command Console, wherein the Command Console comprises a display monitor, a keyboard, and a trackball, and wherein the Command Console is operably coupled to a metal electromagnetic interference (EMI) enclosure, and wherein the EMI Operator Terminal is configured to provide remote access to a first and a second computer via a fiber-optic interface, and wherein the HMI Operator Terminal meets environmental requirements for critical Navy shipboard electronic equipment and also meets data security requirements.

8. The system of claim 7, wherein environmental requirements for critical Navy shipboard electronic equipment include Shock per Military Standard (MIL-S)-901D Grade A, Vibration per MIL-STD-167-1A, EMI per MIL-STD-461F, and humidity and temperature per MIL-STD-810G.

9. The system of claim 8, wherein the EMI enclosure houses electronics equipment.

10. The system of claim 9 wherein the electronics equipment includes a keyboard video mouse (KVM) Extender Receiver, and wherein the KVM Extender Receiver is shock isolated with hemisphere bumpers.

11. The system of claim 10, wherein the EMI enclosure comprises a sealed viewing port.

12. The system of claim 11 wherein the Command Console further comprises at least two console video ports and a plurality of light indicators identifying the computer that has keyboard and mouse control.

13. The system of claim 12 wherein the HMI Operator Terminal is hard mounted.

14. A method for controlling Link systems comprising the steps of:
using a ruggedized operator terminal having a first and a second keyboard video mouse (KVM) extender receiver and a USB switch to remotely access a first computer and a second computer via a fiber-optic interface, and wherein the ruggedized operator terminal comprises a command console having a video display monitor, a keyboard, and a trackball;
sending fiber-optic signals from the first computer and the second computer to the ruggedized operator terminal;
using the KVM Extender Receivers to convert the fiber-optic signals into Digital Video and USB for keyboard mouse (KM) control;
using the USB switch to control KM control between the first computer and second computer;
configuring the ruggedized operator terminal to have KM access for the first computer and a Picture-in-Picture console feature for the second computer;
using a plurality of light indicators to allow identification of the computer that has KM control.

15. The method of claim 14 further comprising the step of:
interfacing the converted Video and USB signals from the EMI enclosure to command console using external cables.

16. The method of claim 15, further comprising the step of using a USB port selection toggle button to control the USB switch for KM control between the first computer and the second computer.

17. The method of claim 16, further comprising the step of hard-mounting the ruggedized operator terminal.

18. The method of claim 17 further comprising the step of:
ensuring the ruggedized operator terminal meets environmental requirements for critical Navy shipboard electronic equipment and also meets data security requirements.
